(19) United States
(12) Patent Application Publication
(10) Pub. No.: US 2016/0238852 A1
(43) Pub. Date: Aug. 18, 2016

(54) HEAD MOUNTED DISPLAY PERFORMING POST RENDER PROCESSING

(71) Applicant: CastAR, Inc., Palo Alto, CA (US)

(72) Inventors: Jeri J. ELLSWORTH, San Jose, CA (US); Kendrick William JOHNSON, Woodinville, WA (US); Ken CLEMENTS, Los Gatos, CA (US)

(21) Appl. No.: 15/043,133

(22) Filed: Feb. 12, 2016

Related U.S. Application Data
(60) Provisional application No. 62/115,874, filed on Feb. 13, 2015.
(60) Provisional application No. 62/135,905, filed on Mar. 20, 2015.
(60) Provisional application No. 62/164,898, filed on May 21, 2015.
(60) Provisional application No. 62/165,089, filed on May 21, 2015.
(60) Provisional application No. 62/190,207, filed on Jul. 8, 2015.

(51) Int. Cl. G02B 27/01; G09G 5/38; G09G 5/00; G09G 5/36; G06T 19/00; G06F 3/01

(52) U.S. Cl. CPC G02B 27/0179; G06T 19/006; G02B 27/0176; G06F 3/012; G06F 3/013; G09G 5/006; G09G 5/363; G09G 5/38; G09G 2340/0464; G09G 2340/14; G02B 2027/0187

(57) ABSTRACT

A head mounted display (HMD) system is disclosed for presentation of visual images in which a post render processing unit (PRU) is built into the HMD to offload operations usually performed by the graphics processing unit (GPU) in the computer that is rendering the computer graphical images (CGI). The PRU takes advantage of local access to tracking and other sensors to reduce the latency traditionally associated with augmented and virtual reality operation.

### CROSS REFERENCE TO RELATED APPLICATIONS

The present application claims the benefit and priority to provisional application 62/115,874, the contents of which are hereby incorporated by reference.

The present application also claims the benefit and priority to the following provisional application Nos. 62/135,905“Retroreflective Light Field Display”; 62/164,898 “Method of Co-Located Software Object Protocol,” 62/165,089 “Retroreflective Fiducial Surface”; 62/190,207 “HMPD with Near Eye Projection,” each of which are also hereby incorporated by reference.

### FIELD OF THE INVENTION

An embodiment of the present invention relates to the art of head mounted displays used to present rendered visual images to users in augmented reality (AR) and virtual reality (VR) applications.

### BACKGROUND OF THE INVENTION

Currently augmented reality (AR) and virtual reality (VR) devices are being manufactured and sold to customers for use in many fields such as business operations, industrial control, education, and consumer entertainment. These systems typically comprise a computer system having a main computer and graphics engine. A mesh model of a scene or game is rendered into a 3D stereoscopic visual presentation and sent, frame by frame, to a head mounted display apparatus worn by a user so as to view the rendered images.

Some limitations arise in these systems because the rendered images must, necessarily, lag behind the real time movements of the user as data from head or eye tracking means in the headsets are transmitted back to these processing systems. This delay is referred to as “latency” in these systems and must be kept as small as a few milliseconds in order to prevent disorientation and other unpleasant sensations, and to promote the illusion of real presence regarding the rendered objects. Further, added processing is often necessary to compensate for deficiencies in the display technology due to optical problems such as spherical and chromatic aberration in the lens systems.

Techniques have been developed to use the time after a frame has been rendered, as a post render process, by the graphic portion of the computer system, to “fix up” its position and/or other properties based on a new head or eye position datum or prediction thereof. This post render process is typically performed by the graphics processing unit (GPU) before the frame is shown to the user. Also, post render actions may be used to correct for optical problems by pre-distorting images in position and/or pixel color, etc. so as to present resulting images to the eyes of the users that represent the desired rendering.

FIG. 1 shows a typical AR/VR arrangement as has been known in the prior art for many years. Here, a workstation computer 101 with a graphics processing unit (GPU) 102 and a CPU 106 and associated GPU port interface is connected by high bandwidth cable 103 to a head mounted display 104.

There also may be input devices or other computer peripherals not shown, and the HMD may have, either video or direct, see-through capability, also not shown. In this figure the cable 103 also carries signals back to the computer from any head or eye position sensing that may be a part of HMD 104.

In the prior art it is typical for the HMD 104 to display images that have been rendered by the GPU 102, the GPU rendering in such a way as to counteract optical aberrations and other problems inherent in the specific HMD design and state of manufacture.

A simplified process flow for the prior art system of FIG. 1 is shown in FIG. 2. In a program such as a simulation of a computer game world, the main loop will first update the state of the virtual world at a given time click, then based on head and/or eye position data received from the HMD, it will then use the GPU to render the user views into that world. If there is a change in user head and/or eye position, it may be necessary to perform a post-render fixup to the images by the CPU or in conjunction with another GPU operation. After the best images have been rendered or fixed up for the most recent position, those images are sent out the video interface of the computer, and on up to the HMD for display to each of the user's eyes.

However, in many cases the post render fixup of the images in the prior art system of FIG. 1 is inadequate to provide an acceptable user experience. This is due, in part, to various sources of latency. There is a small latency associated with transmission through the cable 103. However, more importantly, the computer 101 may be multi-tasking and/or operating an AR/VR application with variable computing demands such that the computer will at times be operating in a slow or overloaded condition such that the transmitted frame rate of rendered frames is reduced. For example, in the case of AR/VR games, some games may have greater frame complexity and require higher frame rates than others.

The computer system 101 may, for example, be a general purpose user computer running background programs. That is the capability of the computer system may be limited and the computer system may be multitasking. Additionally, in the case of an AR/VR program, there may be portions of the program in which the complexity of the program varies. For example, AR/VR games may vary in complexity and have portions of game play in which more processing is required to generate rendered frames.

Additionally, in many consumer applications the user may use the HMD 104 with different computing systems. For example, while some gamers use high-end computers with fast GPUs, more generally there is also a market segment of consumers that utilize computers with slower GPUs, such as mobile devices or general purpose home computers. As a result, the frame update rates may be lower than desired and there may be uneven loading, which can create an unacceptable user experience.

### SUMMARY OF THE INVENTION

An apparatus, system, and method directed to a head mounted display (HMD) includes a post rendering unit (PRU) to perform one or more post rendering processing options on rendered image data received from an external computer. The PRU may be disposed within, attached to, or otherwise coupled to the HMD.

In one embodiment, the PRU reduces a latency in augmented reality (AR) and virtual reality (VR) applications to provide actions such as correction for movement of the user's head or eyes. Additionally, in one embodiment the PRU may be used when the external computer is slow or overloaded. In selected embodiments, the PRU may also perform other adaptations and corrections.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a diagram of a typical AR/VR system in which rendering and post rendering operations are performed in a computer system separate from the head mounted display.

FIG. 2 is a process flow diagram for the system of FIG. 1.

FIG. 3A is diagram of an embodiment of an AR/VR system in which a HMD includes a post rendering unit in accordance with an embodiment.

FIG. 3B is a diagram illustrating elements of AR glasses of an AR system in accordance with an embodiment.

FIG. 4 is a diagram illustrating aspects of a post rendering process in accordance with an embodiment.

FIG. 5 illustrates an example of a post rendering unit of a HMD in accordance with an embodiment.

FIG. 6 is a flowchart illustrating an example of a PRU of a HMD performing fixup of rendered views and predistortion processing in accordance with an embodiment.

FIG. 7 is a flowchart illustrating an example of a PRU filling in frames in accordance with an embodiment.

FIG. 8 is a flowchart illustrating an example of using local sensor data by a PRU to generate integrated display data or an overlay in accordance with an embodiment.

FIG. 9 is a flowchart illustrating an example of generating video subwindows in accordance with an embodiment.

FIG. 10 is a flowchart of an example of a PRU generating additional video content based on a command from an external computer in accordance with an embodiment.

FIG. 11 is a flowchart of an example of a PRU performing processing based on depth buffer data in accordance with an embodiment.

FIG. 12 is a flowchart of a method of a PRU adapting operation of an HMD based on local environmental conditions.

FIG. 13 is a flowchart of an example of a PRU utilizing optical characteristics of an AR system to perform a correction of the AR system.

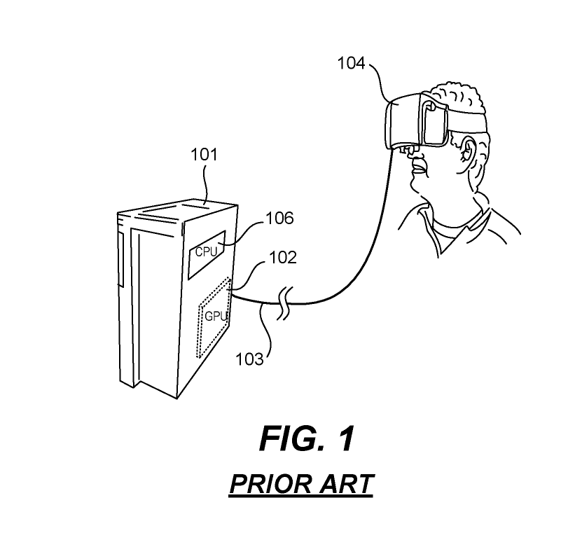

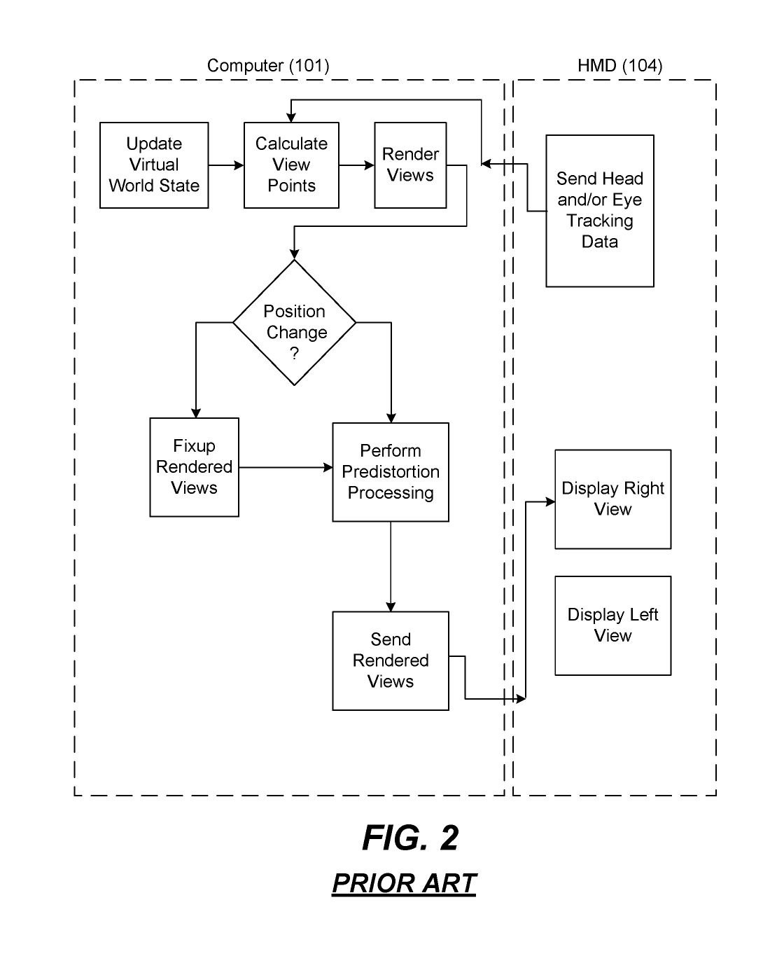

### DETAILED DESCRIPTION

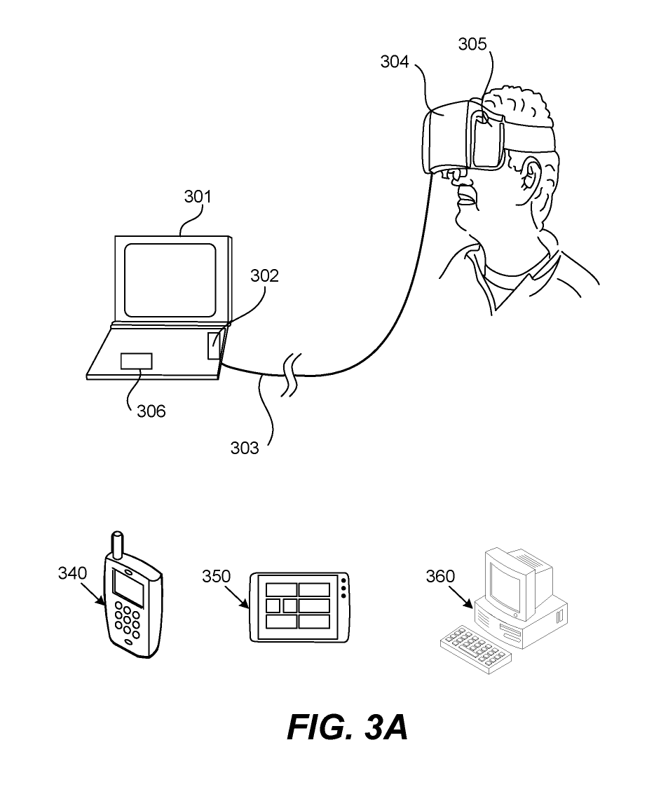

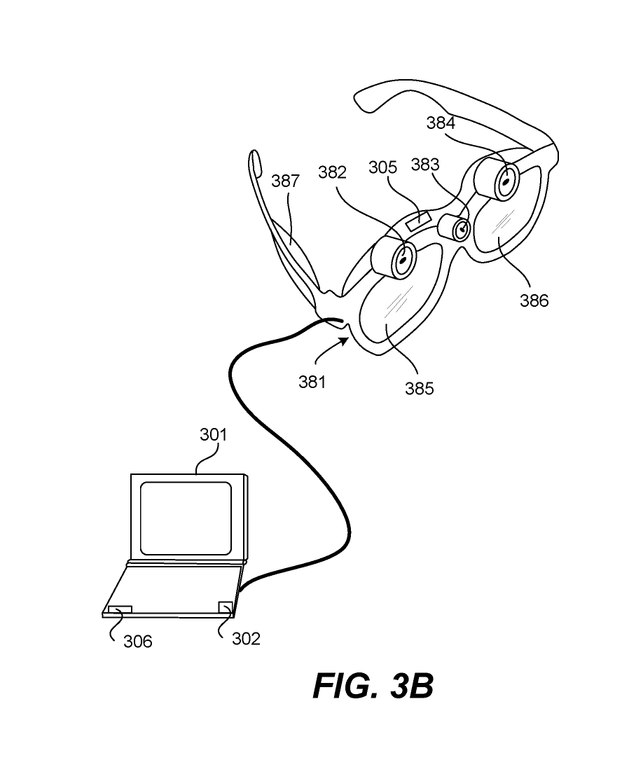

FIG. 3A illustrates an embodiment of a system in which post rendering processing is performed in a head mounted display (HMD) 304. The HMD has a frame shaped to be worn by a user. The HMD 304 includes an image processing system to generate images for each eye of the user. A post render unit (PRU) 305 is mounted within or attached to the HMD 304. The PRU 305 performs one or more post render processing operations, thus offloading post rendering operations from the GPU 302 and CPU 306 in computer system 301. Computer system 301 and its GPU 302 are external to the HMD 304 such that a cable 303 or other communications interface, including wireless links, may be used to support communication between computer system 301 and HMD 304.

The computer system 301 may be a laptop computer. However, more generally, the computer system may be implemented using a computer with different capabilities, such as a smartphone 340 with graphics capability, a slate computer 350, or a desktop computer 360.

One aspect is that offloading one or more post rendering functions reduces the workload on the GPU 302 and CPU 306 to perform post rendering. This facilitates the user selecting a range of computing devices for computer system 301, thus providing advantages in portability and/or cost. Additionally, offloading the post rendering to the HMD 304 provides a possible reduction of the engineering requirements for the high bandwidth cable 303. Additionally, offloading the post rendering to the HMD 304 provides reductions in latency when the user changes their head or eye position.

The PRU 305 has access to local sensor data in the HMD, including motion tracking. The local sensor data may include other types of sensors, such as temperature, lighting conditions, machine vision, etc.

FIG. 3B illustrates an example in which the HMD has a configuration for projected AR applications. A frame 381 supports an image display system comprising a pair of pico-projectors 382, 384 and a movement tracking module 383 to track the motion of a user's eyes and/or head. The movement tracking module 383 may include inertial sensors or other motion sensors. The movement tracking module 383 may be used to generate tracking data from which the user's head and eye position may be calculated. Images are returned to the user by means of a retroreflective screen (not shown) together with view lenses 385, 386. A tracking marker may be provided using various techniques, such as by infrared imaging in the movement tracking module 383. The PRU 305 may be attached to or mounted within a portion of the frame 381.

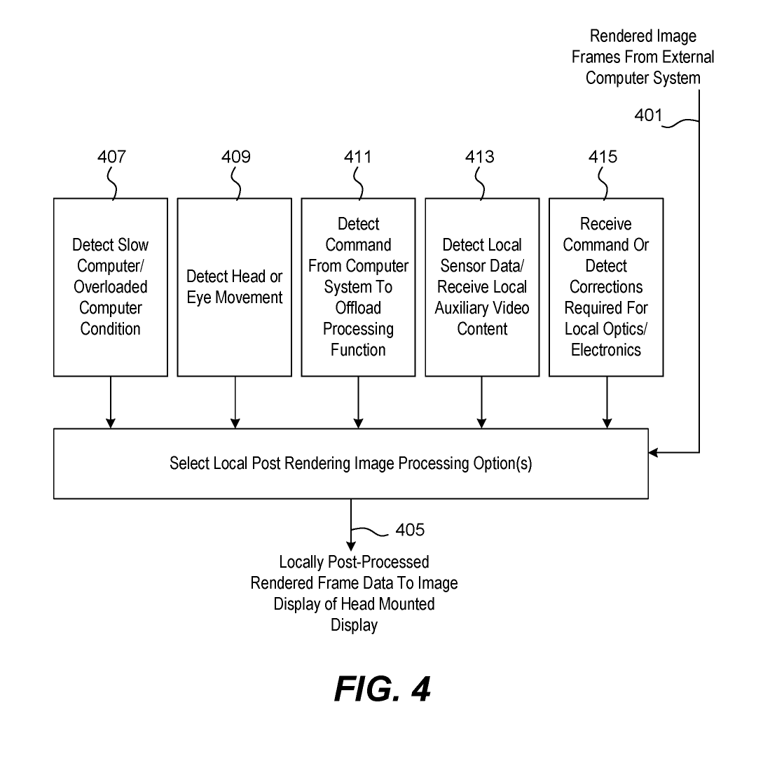

FIG. 4 illustrates a general method performed by the PRU 305 in accordance with an embodiment. The PRU 305 receives rendered image frames from the GPU of an external computer system 301. The PRU determines whether there is a condition requiring post rendering processing and selects 403 a local post-rendering image processing option and provides processed rendered frame data 405 to the image display portion of a head mounted display. Among the criteria the PRU 305 may use to make decisions include detecting a slow/overloaded condition in the external computer system 407, detecting head or eye movement based on local motion tracking data 409, detecting a command from the external computer system to perform a post rendering operation 411, detecting other local sensor data or video content to display 413 (e.g., a user's heart rate, skin resistance, eye blink, etc.), and receiving a command or detecting a condition requiring corrections to local optics or electronics (e.g., temperature, humidity, local lighting intensity, and local color spectrum).

The PRU 305 may make its selection based on various inputs and sub-processes. The decisions may be triggered based on detecting minimum thresholds (e.g., a frame rate of received rendered frames from the GPU falling below a threshold frame rate; head or eye motion exceeding one or more thresholds for a current change in position or a prediction change in position). However, other rules besides a minimum threshold may be utilized. More generally, a rules engine or rules table may be used by the PRU 305 to select a post rendering processing operation based on a set of inputs.

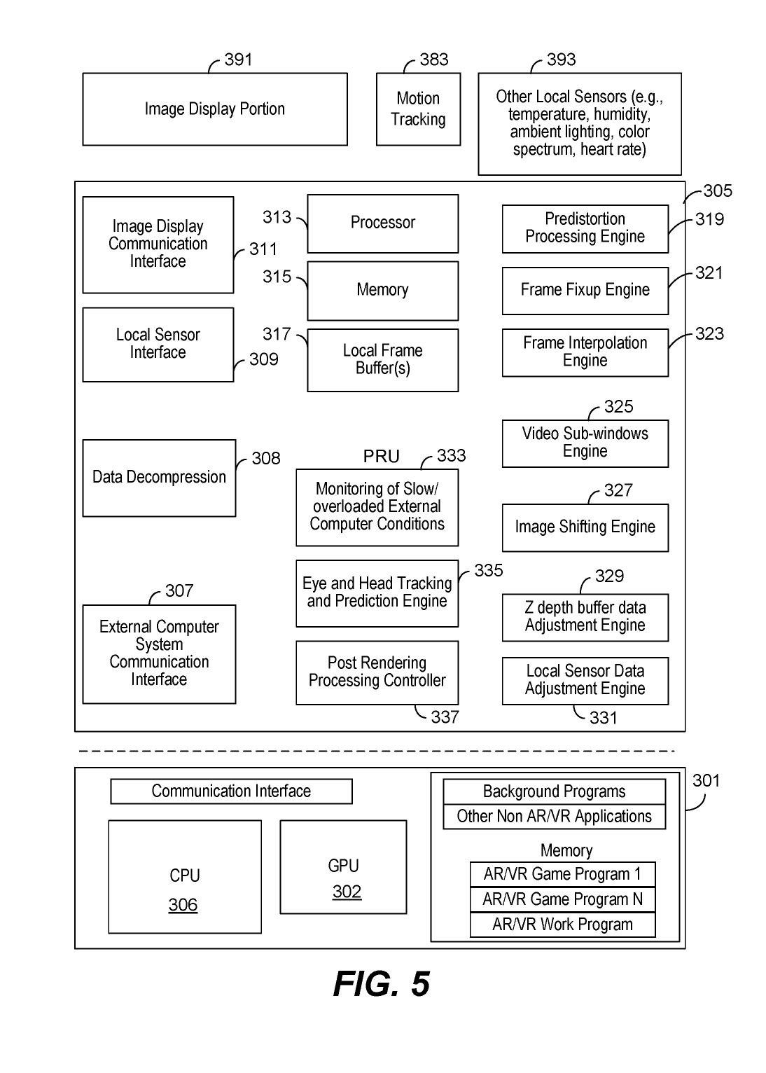

FIG. 5 is a block diagram of an implementation of the PRU 305 in accordance with an embodiment. The PRU 305 is illustrated in the larger use environment that includes components of the HMD, such as an image display portion 391, movement tracking monitor 383, and other local sensors 393, which may include environmental sensors and machine vision. The PRU 305 includes interfaces to communicate with other components, such as an external computer system communication interface 307, a local sensor interface 309, and an image display interface 311. The PRU includes at least one processor 313 and a memory 315. A local memory used as a frame buffer 317 may be provided to support generating interpolated frames from one or more previous received rendered frames and/or selecting a previously rendered frame for re-use.

The post rendering operations may be implemented in different ways. However, it will be understood that individual aspects may be implemented by one or more processing engines implemented as hardware, firmware, or as software code residing on a non-transitory computer readable medium. In one embodiment the PRU 305 includes a predistortion engine 319 and a fixup engine 321 to adapt a frame based on changes in user eye or head position. A frame interpolation engine 323 generates interpolated frames based on one or more conditions, such as detecting head or eye motion or detecting a slowdown in the external computer system. A video sub-windows engine 325 supports adding one or more video sub-windows to the displayed image. An image shifting engine 327 supports shifting an image in time or in position. A Z buffer adjustment engine 329 supports performing adjustments of the image based on Z-buffer depth data provided by the external computer. A local sensor data adjustment engine 331 performs adjustment of the processing based on local sensor data, which may include environmental data and machine vision data. An engine 333 may be included to specifically monitor slow or overloaded conditions of the external computer. An eye and head tracking and prediction engine 335 monitors local sensor motion sensor data, determines the current head and eye position of the user, and may also predict the user's head and eye position one or more frames ahead of its current position. A post rendering processing control 337 may be provided to receive inputs from other engines and modules and make decisions on which post rendering operations are to be performed at a given time.

FIG. 5 also illustrates an application environment in which the external computer system 301 runs different programs and applications. The external computer system 301 may run background programs, such as anti-virus programs, that create a variable load on the external computer system. In addition, the external computer system 301 may execute a variety of different AR/VR games or AR/VR work programs. As a result, in some circumstances the external computer system 301 may experience a temporary slowdown or overload condition based on what programs it is currently executing and the capabilities of its CPU and the GPU. The use of the PRU 305 in the HMD 304 to offload post rendering processing operations thus expands the games and other software that may be run without the disruption and simulator sickness problems introduced by a computer and GPU that are not keeping up with the minimum desired frame rate or when the head and eye movement of the user exceeds a threshold level.

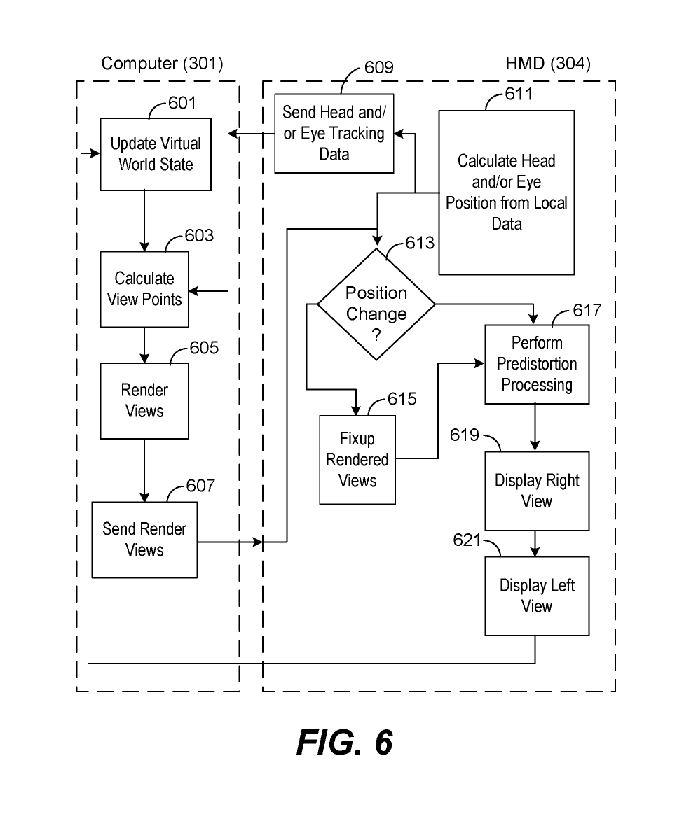

FIG. 6 illustrates an example in which fixup of rendered views and predistortion processing is performed by the PRU 305 in the HMD 304. The computer system 301 performs various operations to generate rendered frames for AR/VR applications, such as updating a virtual world state 601, calculating view points 603, rendering views 605, and sending rendered views 607. The HMD sends head and/or eye tracking data 609 to the computer system 301 to adjust the calculated view points. The head or eye position is calculated by the PRU from local data.

The PRU 305 calculates position changes 613 and generates fixed up rendered views 615 and performs predistortion processing 617 prior to sending the processed image data to the left and right eye displays 619, 621. The PRU 305 can perform the fixup and predistortion operations more quickly than the computer system 301 for a variety of reasons. One reason is that there is a potential time savings for the PRU 305 to perform these operations because the motion tracking sensors are local to the HMD, permitting the PRU to better manage the post render fixup and predistortion processing steps in the HMD. Additionally, there is a potential time savings for the PRU to perform these operations because of the latencies associated with the cable or wireless interface delays and any time required for the CPU and GPU to respond, which may depend on how busy the computer system 301 is. In one embodiment, the PRU need not wait for complete images to be transferred to begin its work, but may begin to process these with just a few lines of video transferred, and then rapidly proceed in a pipelined method through the rest of the frame.

As an additional example, the PRU 305 may predict the head or eye position of the user and shift an image presentation based on the predicted head or eye position of the user. As another example, the post rendering unit may place or adjust an image view in a wide angle projected image based on head or eye position of the user.

The PRU 305 may perform a variety of different post rendering processing operations, depending on implementation details. For example, in displays that utilize liquid crystal on silicon (LCoS) technology, a problem occurs when user head movement causes the flashes of the different colors that make up the video pixels to be seen as spread in distance, thus smearing. In one embodiment, the PRU may counter this by shifting the images of the primary color planes in accord with the head motion such that each flash puts the pixels in the same place on the user retina, which causes the colors to combine properly into the desired image.

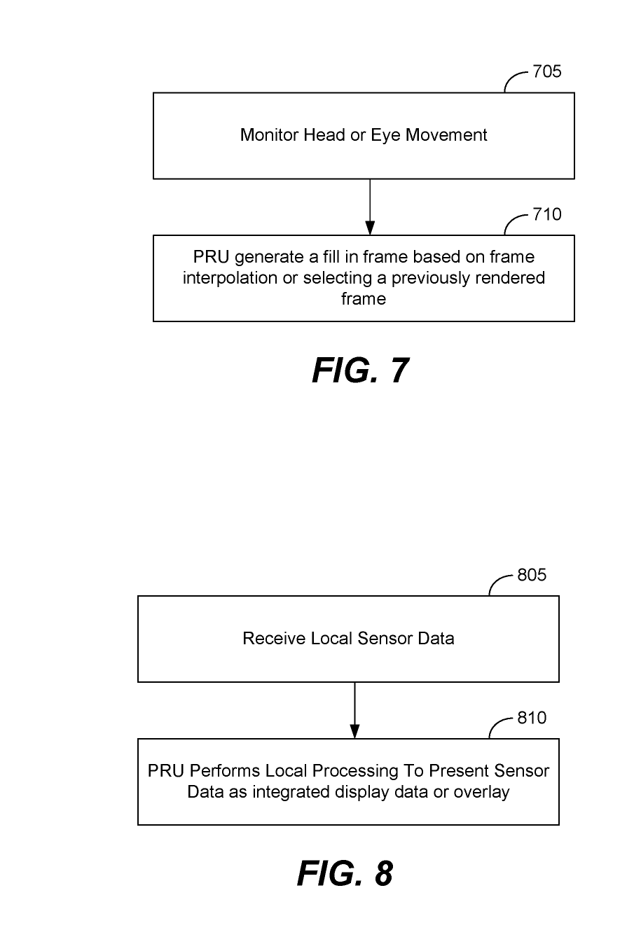

In general, many AR/VR applications may be improved by a higher frame rate in the display. Often this is limited by the capability of the main computer and its GPU. Referring to FIG. 7, in one embodiment of the present invention, the PRU monitors head or eye motion data 705 and in response generates a “fill in” frame 710 based on interpolating frames or by selecting among pre-rendered frames, based on head or eye motion data, so as to fill in frame data while the main computer and GPU are still calculating the next full render. Additionally, the fill in frame 710 may alternatively be generated in response to other conditions, such as a slow or overloaded computer condition.

Referring to FIG. 8, in one embodiment the PRU may introduce overlay or integrated display information in general, and specifically, information that may relate to sensors that are in the HMD itself. In particular, the PRU may receive local sensor data 805 and generate the overlay or integrated display information 810. As illustrative examples, the sensors might be monitoring temperature of the room or the user's body, or heart rate or any number of other local parameters that are not part of the program being run by the computer and its GPU.

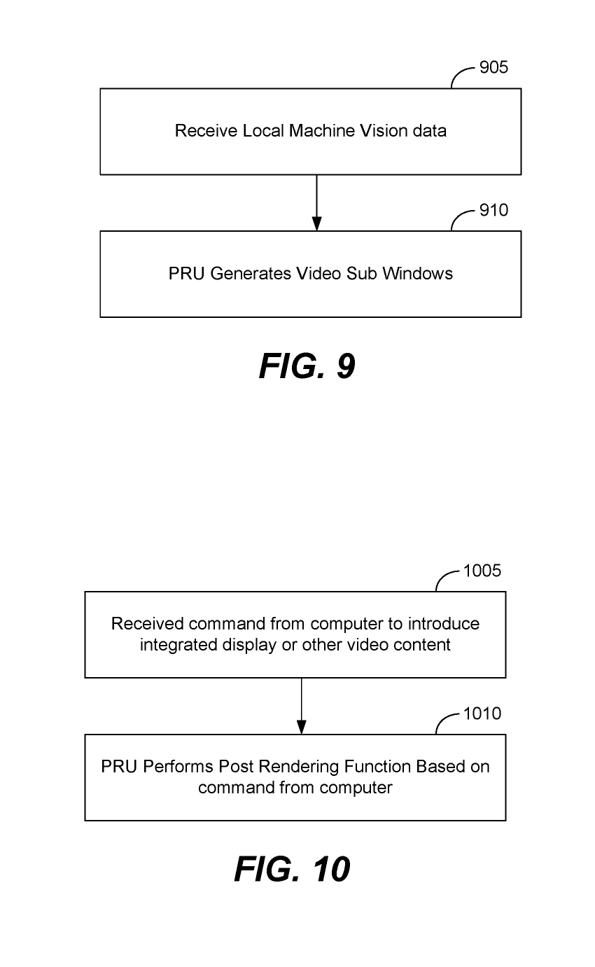

Referring to FIG. 9, in one embodiment the PRU may receive local computer vision data 905 and introduce additional video material 910. The computer vision data may be generated by one or more local sensors. For example, the added information may include video sub windows that help the user navigate the physical space around him/her. In the VR case this is important for preventing running into physical objects and walls. In the case of AR, the information might be a result of object recognition by computer vision means also running in the headset independently of the CPU and GPU of the external computer system 301.

Referring to FIG. 10, in one embodiment, the PRU may introduce integrated display information or video subwindows in response to a command from the computer system 301. For example, the PRU may receive a command 1005 from the CPU to perform 1010 a particular post rendering function, such as adding an integrated display element or a video subwindow. The PRU then implements the command For example, content may be selectively introduced by the PRU in some games or applications in which the program is written to send a message to the HMD to take over functions in order to reduce the load on the computer or GPU. As an example, a game may send a command for the HMD to put a clock or timer or heart rate display in part of the visual field.

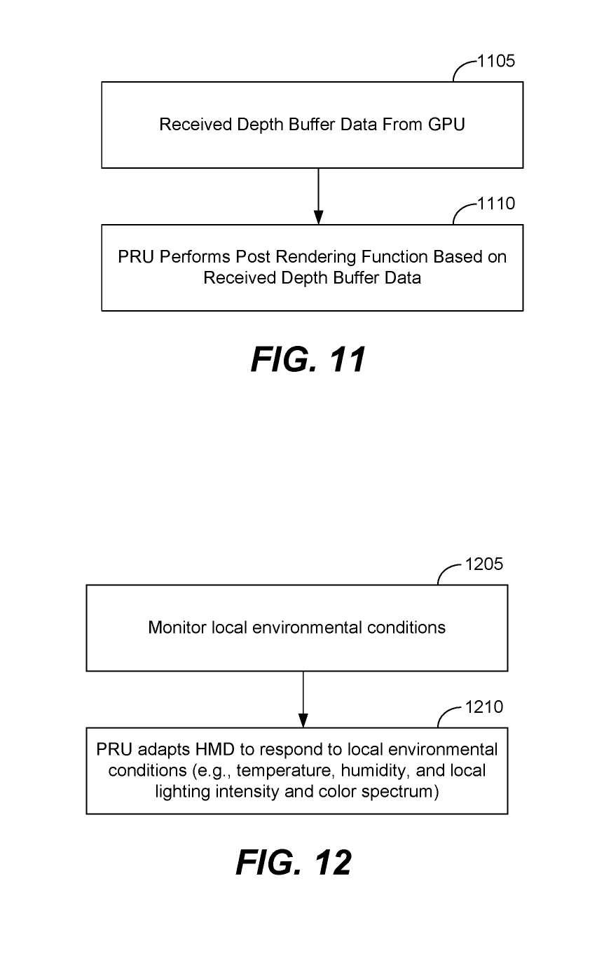

Referring to FIG. 11, in one embodiment the PRU receives depth buffer data from the GPU 1105 and performs a processing operation based on the depth data 1110. As another example, the PRU may perform blanking of occluded video. Embodiments of the invention may include the PRU receiving a depth buffer supplied by the GPU of the external computers Implementations of scene rendering by GPU often cause that GPU to generate a buffer holding the “z” coordinates or “depth” of the pixels as they would reside in three dimensions. This information, if passed by the GPU to the PRU, supports the PRU performing operations such as parallax adjustment in interpolated frames, or provides for depth queuing by inserting light field focal planes or shading or blurring of distant pixels. The “z” buffer may also be used by the PRU to blank out parts of frames in an AR context, when information from computer vision or other means indicates that real objects are in front of rendered objects in the received frames. This kind of blanking greatly adds to the sense of realism in AR systems.

Referring to FIG. 12, in one embodiment, the PRU 305 receives 1205 data on local environmental conditions and adjusts 1210 the projector, or other display, output of the HMD based on the local environmental conditions. As examples, this may include an analysis of room lighting intensity and color spectrum as well as correcting for optical distortion introduced by temperature/humidity changes, etc. For example, the local sensors may include room lighting, color spectrum sensors, temperature sensors, and humidity sensors.

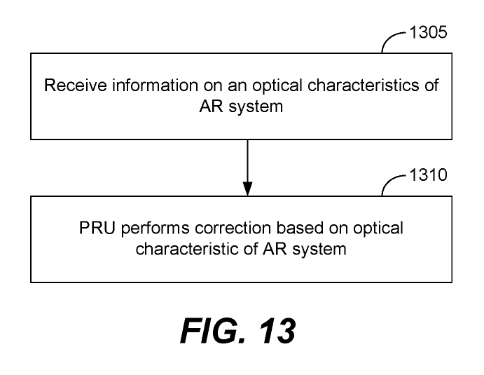

Referring to FIG. 13, in one embodiment of an AR HMD, the PRU 305 may perform image correction operations specific to a projected AR headset implementation screen. This may include monitoring an optical characteristic 1305 of the AR system and performing a correction based on the monitored characteristic.

In particular, a projected AR headset may have moving mirrors or other optics that, synchronized with eye tracking, sweep the projection from side to side, or both side to side and up and down, keeping the projected image centered with respect to the user's eyes, thus providing a nearly fovial display. The result of this directed projection is to give the effect of substantially higher resolution when the light from the images is returned by a retroreflective screen. In such an embodiment the GPU would be rendering over much wider a view than the projectors can project, while the PRU selects a slice of that render that centers on the fovial retina. While the user's eyes move across, the main GPU need not re-render the scene as long as the eyes are pointed within a bound that can be serviced by the PRU.

In the case of using projection onto the retroreflective surface, the PRU may receive information regarding the surface optical characteristics encoded with the tracking information such that the PRU can correct for different color reflectance per surface and per angle of projection.

One of the benefits of moving the predistortion (dewarp) operations into the PRU is that the interface to the HMD can be standardized as in the cases of current video projector interfaces. The interface for a commercial 3D video projector or monitor could be an example. By following such a standard, the operation of the main computer and its GPU is simplified, as if it were rendering for such a display (useful to have image stabilization done by the PRU), and the HMD may then have the capability to be plug-compatible with these displays so that it can show either 2D or 3D video productions. The PRU equipped HMD may also use its tracking ability to show expanded views of otherwise prerecorded videos, or view live teleconferences by line of sight. Similar applications may present themselves in the area of viewing remote scenes such as in security operations.

In one embodiment, the PRU 305 receives compressed video rendered by the CPU and GPU. As illustrated in FIG. 5, the PRU may support data decompression 308. In such embodiments, the ability of the PRU to use the compact coded form of video frames may result in an advantage by allowing a lower bandwidth technology to be used for the interconnect 303 or even allow for that interconnect to be achieved over wireless link or wireless local network such as Bluetooth, ZigBee or IEEE 802.11, which may be routed to a wide area network such as the Internet.

While various individual features and functions of the PRU 305 have been described, it will be understood that combinations and subcombinations of the features are contemplated. For example, one or more rules may be provided to enable or disable individual functions or their combinations and subcombinations.

It will be understood that criteria for determining when specific modes of operation of the PRU 305 are triggered may be determined in view of various considerations. One consideration in adapting to changes in user head or eye position and/or a computer slowdown or overload condition is latency. Latency in an AR/VR system should generally be kept as small as a few milliseconds in order to prevent disorientation and other unpleasant sensations, and to promote the illusion of real presence. Thus, criteria to determine when specific functions of the PRU 305 are activated may be determined for a particular implementation based on an empirical determination of keeping latency low enough to achieve a pleasant user experience for AR/VR games of interest with external computer systems having a given range of capabilities. For example, the PRU may be designed to improve the operation of AR/VR systems based on augmenting the types of external computing platforms many consumers already have.

In an AR system with projection optics the angle of incidence with respect to the reflective or retroreflective surface is an important consideration. In particular, the image quality and brightness are a function of the angle of incidence with respect to the reflective or retroreflective surface. In one embodiment, the HMD projects images to be returned via a reflective or retroreflective surface and the PRU 305 determines an adjustment based on the angle of incidence of the projection with respect to the surface. In one embodiment the PRU adjusts projection options of the HMD based on the angle of incidence.

Additional background information on HMDs, tracking, motion sensors, and projection based system utilizing retroreflective surfaces and related technology is described in several patent applications of the Assignee of the present application. The following US patent applications of the Assignee are hereby incorporated by reference in their entirety: U.S. application Ser. No. 14/733,708 “System and Method For Multiple Sensor Fiducial Tracking,” Ser. No. 14/788,483 “System and Method for Synchronizing Fiducial Markers,” Ser. No. 14/267,325 “System and Method For Reconfigurable Projected Augmented Virtual Reality Appliance,” Ser. No. 14/267,195 “System and Method to Identify and Track Objects On A Surface,” and Ser. No. 14/272,054 “Two Section Heat Mounted Display.”

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), optical MEMS, or the like, may also be used without departing from the scope and spirit of the inventive concepts disclosed herein. The present invention may also be tangibly embodied as a set of computer instructions stored on a computer readable medium, such as a memory device.

What is claimed is:

1. A head mounted display apparatus comprising:
a frame shaped to be mounted on a user's head;
an image display system supported by said frame;
a motion sensor to track head or eye motion of the user;
an interface to communicate with an external computer system having a graphics processing unit to generate rendered image data; and
a post rendering unit coupled to said frame to execute auxiliary image processing upon rendered image data received from said external computer system before passing said rendered image data to said image display system.

2. The head mounted display apparatus of claim 1, wherein said post rendering unit performs a post rendering operation based on environmental conditions and deficiencies in the electronics or optics of said image display system.

3. The head mounted display apparatus of claim 1, wherein said post rendering unit determines corrections to rendered image data based on motion tracking data indicative of a head or eye position of a user.

4. The head mounted display apparatus of claim 3, wherein said post rendering unit generates interpolated intermediate image frames.

5. The head mounted display apparatus of claim 3, wherein said post rendering unit shifts an image view window into a wide angle image based on head or eye position of the user.

6. The head mounted display apparatus of claim 3, wherein said post rendering unit predicts the head or eye position of the user and shifts an image presentation based on the predicted head or eye position of the user.

7. The head mounted display apparatus of claim 1, wherein said post rendering unit decompresses image data received from the external computer system.

8. The head mounted display apparatus of claim 1,wherein said post rendering unit adds image data to a stream of rendered image data to display of information from sensors located on or within said head mounted frame.

9. The head mounted display apparatus of claim 1, wherein said head mounted display apparatus calculates head and eye corrections from local motion tracking data, and in response performs at least one of fixing up rendered views and predistortion processing of rendered image data.

10. The head mounted display apparatus of claim 1, where said head mounted display apparatus monitors frame transmission rates of rendered image data and performs a post rendering processing operation in response to detecting a received frame rate below a threshold rate.

11. The head mounted display apparatus of claim 10, wherein at least one of frame fixup, predistortion, and frame interpolation is performed in response to detecting a frame rate corresponding to a slow or overloaded computer condition and based on tracking data indicative of a head or eye position of the user.

12. The head mounted display apparatus of claim 1, wherein said post rendering unit introduces a video sub-window for user navigation.

13. The head mounted display apparatus of claim 1, wherein said post rendering unit introduces video content based on local sensor data accessed by said post rendering unit.

14. The head mounted display apparatus of claim 1, wherein said post rendering unit receives depth buffer information from said computer system via said communication interface and said post rendering unit utilizes said depth buffer information to perform at least one of parallax adjustment in interpolated frames, inserting light field focal planes, shading distant pixels, blurring distant pixels and/or blanking of occluded regions of a frame.

15. The head mounted display apparatus of claim 1, wherein said post rendering unit is activated to reduce the load on said external computer system in response to receiving a command from said computer system via said communication interface.

16. The head mounted display apparatus of claim 1, wherein said post rendering unit has at least one post rendering operation triggered by a command from a computer game executing on said external computer system to offload a function from said external computer system to said post rendering unit.

17. A method of operating a head mounted display, comprising:
receiving, at a head mounted display, rendered image data from an external computer system;
monitoring, by a monitor within or attached to said head mounted display, one or more conditions indicative of a post rendering processing requirement; and
performing, by said head mounted display, local post render processing of said rendered image data prior to displaying image data by said head mounted display, said post render processing being performed in response to detecting a condition in which post rendering processing is required.

18. The method of claim 17, wherein said head mounted display acts to project images to be returned by a reflective or retroreflective surface and wherein said condition in which post rendering processing is required is based on an angle of incidence of said projection with respect to said surface.

19. The method of claim 17, wherein said performing comprises performing a post rendering operation based on environmental conditions and deficiencies in at least one of electronics or optics of an image display system of said head mounted display.

20. The method of claim 17, wherein said performing comprises determining corrections to rendered image data based on motion tracking data indicative of a head or eye position of a user.

21. The method of claim 20, wherein said performing comprises generating interpolated intermediate image frames.

22. The method of claim 20, wherein said performing comprises shifting an image view window into a wide angle image based on head or eye position of the user.

23. The method of claim 20, wherein said performing comprises predicting the head or eye position of the user and shifting an image presentation based on the predicted head or eye position of the user.

24. The method of claim 20, wherein said performing comprises shifting an image view in a wide angle projected image based on head or eye position of the user.

25. The method of claim 17, wherein said performing comprises adding image data to a stream of rendered image data to display of information from sensors located on or within said head mounted display.

26. The method of claim 17, wherein said performing comprises determining head and eye corrections from local motion tracking data, and in response performing at least one of fixing up rendered views and predistortion processing of rendered image data.

27. The method of claim 17, wherein said monitoring comprises monitoring frame transmission rates of rendered image data and said performing comprises performing a post rendering processing operation in response to detecting a received frame rate below a threshold rate.

28. The method of claim 27, comprising performing, at least one of frame fixup, predistortion, and frame interpolation in response to detecting a frame rate corresponding to a slow or overloaded computer condition and based on tracking data indicative of a head or eye position of the user.

29. The method of claim 17, wherein said performing comprises introducing a video sub-window for user navigation.

30. The method of claim 17, wherein said performing comprises introducing video content based on local sensor data accessed by said head mounted display.

31. The method of claim 17, wherein said performing comprises receiving depth buffer information from said external computer system and utilizing said depth buffer information to perform at least one of parallax adjustment in interpolated frames, inserting light field focal planes, shading distant pixels, blurring distant pixels and/or blanking of occluded regions of a frame.

32. An apparatus comprising:
a post rendering unit configured to operate in a head mounted display and execute auxiliary image processing upon rendered image data received from an external computer system before passing said rendered image data to an image display system of said head mounted display.
